(19) United States
(12) Patent Application Publication
(10) Pub. No.: US 2012/0298809 A1
(43) Pub. Date: Nov. 29, 2012

(54) CABLE HANGER

(76) Inventor: Adam William Preedy, Ridgmont (GB)

(21) Appl. No.: 13/480,936

(22) Filed: May 25, 2012

(30) Foreign Application Priority Data
May 25, 2011 (GB) 1108819.2

(51) Int. Cl. F16L 3/08

(52) U.S. Cl. 248/65

(57) ABSTRACT

A cable hanger comprising a main body section having an attachment face and a front face, and an elongate tongue section, wherein the tongue section is attached at one end to the main body section by way of an attachment region and has a free end, the front face has raised edge portions and a central portion, the central portion being located generally opposite the tongue section, and the edge portions protruding outwardly by a greater amount than the central portions, and a retaining region is defined between the front face of the main body section and a rear face of the tongue section, the retaining region being capable of accommodating and retaining a cable.

The present disclosure relates to devices for hanging or anchoring cables, especially for hanging cables on or attaching cables to walls, particularly in a construction or building-site environment.

In general, cable hangers and cable clips are which are permanently affixed to a surface are well-known, particularly where it is desired to route mains-voltage, satellite or network cable. In these instances, nailed or permanently affixed cable clips are used or, alternatively, cable conduit may be used to route the cable.

In a construction or building-site environment, health and safety regulations or guidelines dictate that all cabling including mains, low-voltage and similar cabling must be safely lifted and retained away from the floor to avoid trips, slips, falls and cutting of or damage to the cable or cables. It is not desired to route cabling or power lines for tools permanently, as these tools will be removed from site once construction or maintenance works are completed. Presently, tie-wraps and cloth tape are regularly used for this purpose, to secure cables or permanent hooks are affixed to a wall or structure in order to provide support for the cable. Alternatively, the cables are left to run along floors or stairs in an unsafe manner.

Permanent hooks are an improvement on nailed cable clips and cloth tape, as hooks allow for easy removal and relocation of the cable when it is desirable to change or relocate tools and/or appliances.

The present disclosure seeks to provide an improved cable hanging and/or tidying system.

Accordingly, one aspect of the present disclosure provides a cable hanger comprising a main body section having an attachment face and a front face, and an elongate tongue section, wherein the tongue section is attached at one end to the main body section by way of an attachment region and has a free end, the front face has raised edge portions and a central portion, the central portion being located generally opposite the tongue section, and the edge portions protruding outwardly by a greater amount than the central portions, and a retaining region is defined between the front face of the main body section and a rear face of the tongue section, the retaining region being capable of accommodating and retaining a cable.

Another aspect of the present disclosure provides a cable hanger comprising a main body section having an attachment face, a front face, a first edge and a second edge, and an elongate tongue section, wherein the tongue section is attached at one end to the main body section and has a free end, the front face has a central portion, the central portion being located generally opposite the tongue section, the first edge and second edge are so shaped as to be complementary, the first edge having a first attachment arrangement and the second edge having a second attachment arrangement, the first and second attachment arrangements cooperate with each other such that if the first edge of the hanger is placed against the second edge of an identical hanger, the first and second attachment arrangements engage with one another and register the hanger and the identical hanger in place with respect to one another, the tongue portion has an inner face which is generally opposite the front face of the central portion, and a retaining region is defined between the front face of the main body section and the inner face of the tongue section, the retaining region being capable of accommodating and retaining a cable.

Preferably, the first and second attachment arrangements are complimentary rabbets.

Alternatively, the first and second attachment arrangements are formed of a tongue-and-groove.

A further aspect of the present disclosure provides a cable hanger comprising a main body section having an attachment face and a front face, and an elongate tongue section, wherein the tongue section is attached at one end to the main body section and has a free end, the front face has a central portion, the central portion being located generally opposite the tongue section, the tongue portion has an inner face which is generally opposite the front face of the central portion, the inner face and/or the central portion having an undulating surface, with spaced-apart ridges running perpendicular to the elongate axis of the tongue section, a retaining region is defined between the front face of the main body section and the inner face of the tongue section, the retaining region being capable of accommodating and retaining a cable, between adjacent ridges.

A yet further aspect of the present disclosure provides a cable hanger comprising a main body section having an attachment face and a front face; and an elongate tongue section, wherein the tongue section is attached at one end to the main body section and has a free end, the front face has a central portion, the central portion being located generally opposite the tongue section, the tongue portion has an inner face which is generally opposite the front face of the central portion, the inner face and/or the central portion having a high-grip surface which comprises a region of a different material, or is treated or formed to grip a cable, a retaining region is defined between the front face of the main body section and the inner face of the tongue section, the retaining region being capable of accommodating and retaining a cable.

Preferably, at least a section of the tongue portion or front face is formed of or includes a high-grip surface which comprises a region of a different material, or is treated or formed to grip a cable.

Conveniently, the high-grip surface is a roughened surface.

Alternatively, the high-grip surface is a textured surface.

Alternatively, the high-grip surface is formed of a plastics material.

Alternatively, the high-grip surface is formed of a rubber material.

Advantageously, the elongate tongue section has a curved shape, such that a central portion of the tongue section is closer to front face of the main body section than edge sections of the tongue section.

Conveniently, the tongue section is attached to the main body section by way of an attachment region.

Preferably, the tongue section is substantially flat.

Conveniently, a central portion of the tongue section is closer to the main body section than the outermost part of the edge portions.

Advantageously, the attachment face includes an attachment arrangement.

Preferably, the attachment arrangement comprises an adhesive pad.

Conveniently, a fold-out cover is provided which may be moved into place to cover the attachment arrangement.

Advantageously, apertures are provided through the main body section.

Preferably, the edge portions extend substantially all of the way around the outer edge of the front face.

Alternatively, the edge portions extend part of the way around the outer edge of the front face.

Conveniently, at least a section of the edge portion is formed of or includes high grip material.

Advantageously, an outer surface of the tongue portion includes a reflector.

Preferably, a strap or straps are provided, extending generally away from an outer perimeter of the main body section.

Conveniently, the straps are flexible.

Advantageously, the straps include fixing arrangements.

Preferably, opposing straps include complementary fixing arrangements to allow closure of the straps.

Conveniently, retaining arrangements are provided on at least one of the straps.

Advantageously, retaining arrangements are clips for cables or similar flexible members.

Preferably, the cable hanger is provided with an affixing arrangement which may be used to affix the cable hanger to a surface and subsequently re-used.

Conveniently, the affixing arrangement is releasably attached to the cable hanger.

A further aspect of the present disclosure provides a hanging arrangement comprising a cable hanger having a main body section having an attachment face and a front face, an elongate tongue section, the tongue section attached at one end to the main body section and has a free end, a retaining region of a defined between the front face of the main body section and a rear face of the tongue section, and an attachment arrangement having an engagement portion and a hanging portion, the engagement portion shaped to receive the tongue section of the cable hanger, and the hanging portion being shaped so that an object may hang thereon.

Preferably, the hanging portion is trough-shaped.

Alternatively, the hanging portion is peg-shaped.

Alternatively, the hanging portion is shaped to be larger than the retaining region of the cable hanger.

Conveniently, the attachment further includes a stabilising leg.

The embodiments of the present disclosure will now be described, by way of example only, with reference to the figures, in which:

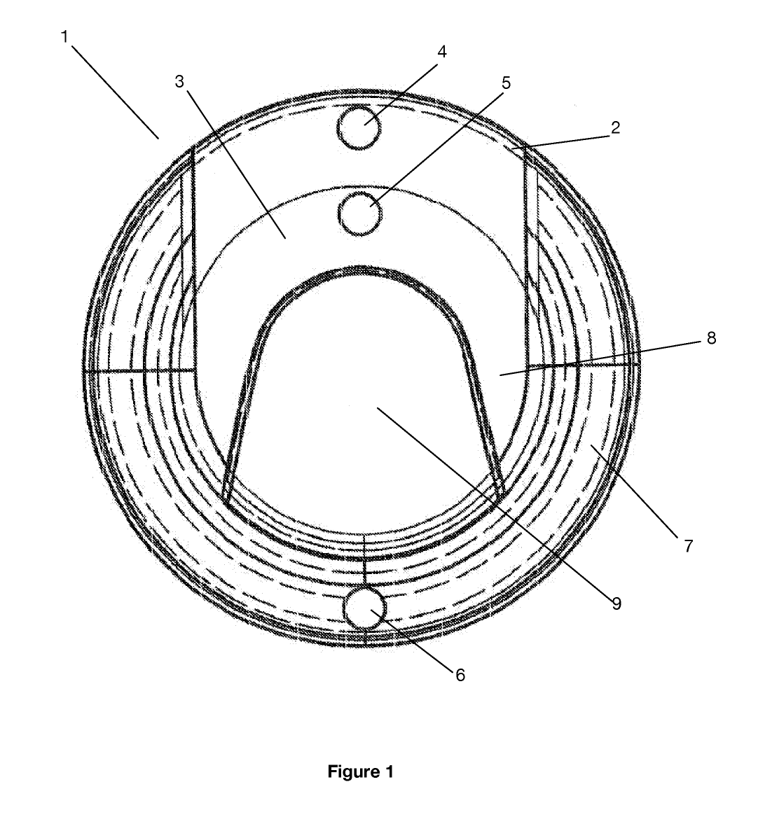

FIG. 1 shows an example of a cable hanger;

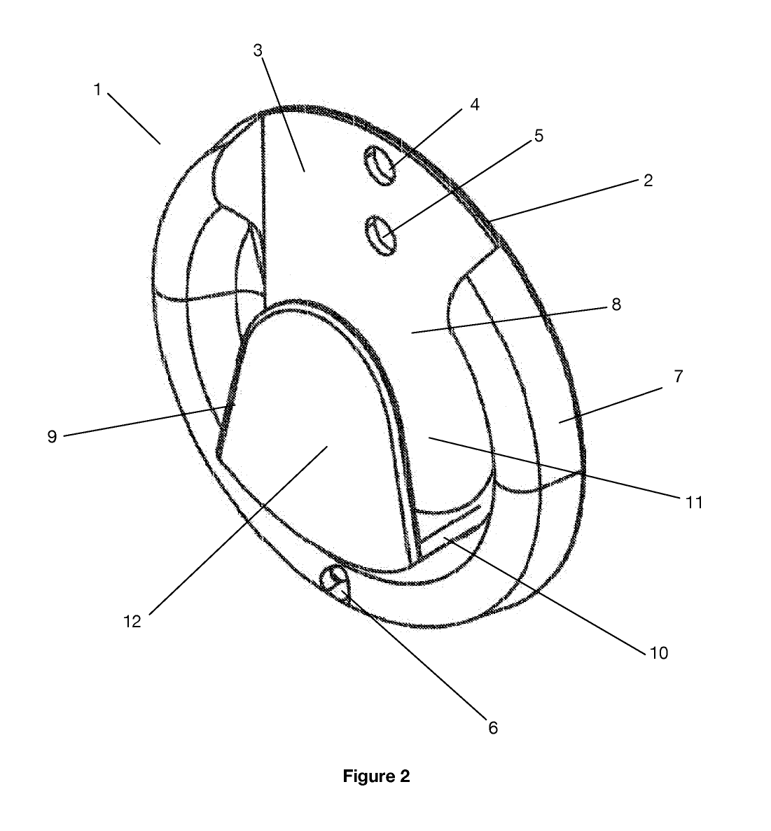

FIG. 2 shows an alternative view of the cable hanger of FIG. 1;

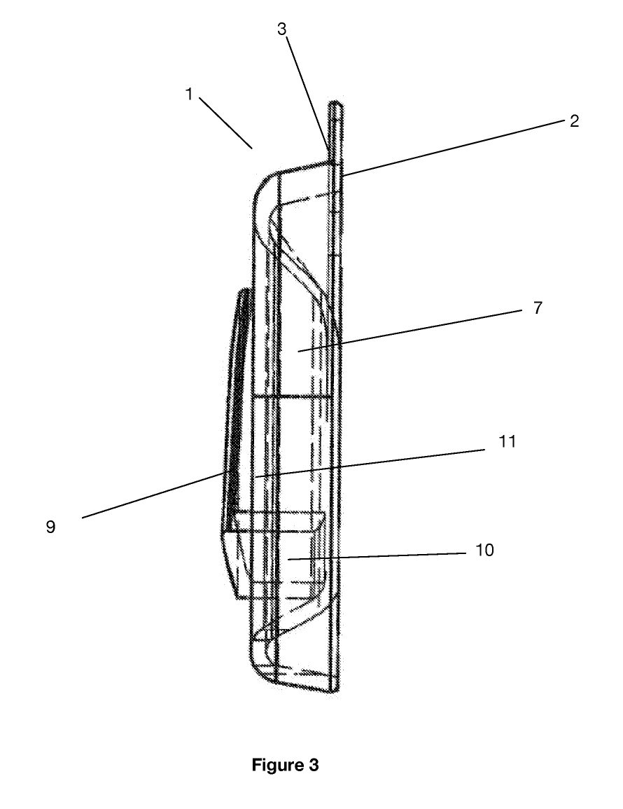

FIG. 3 shows a yet further view of the cable hanger of FIG. 1;

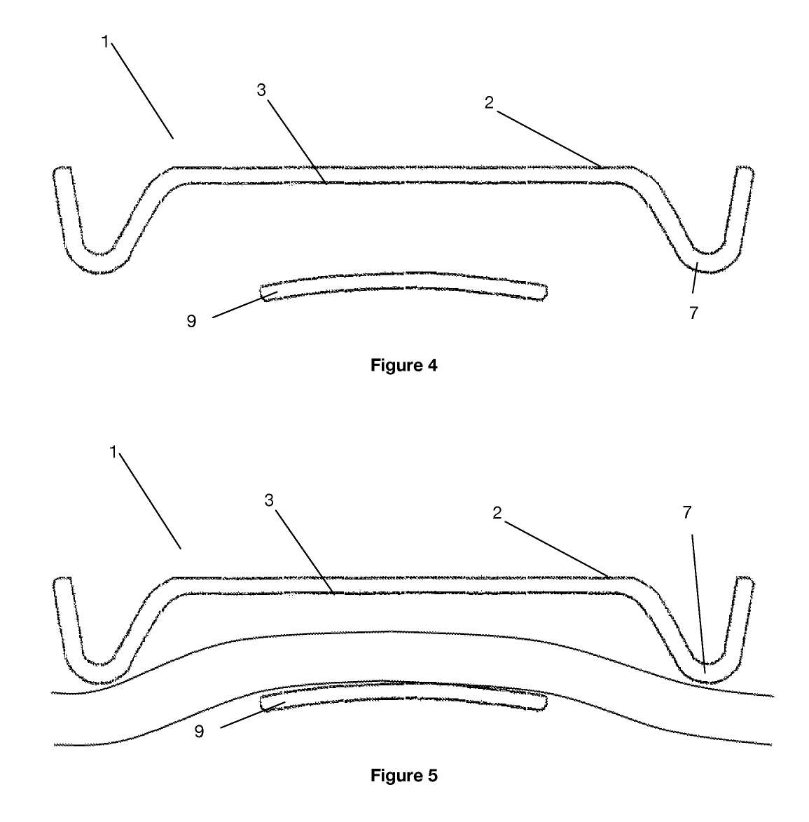

FIG. 4 shows a sectional view of a cable;

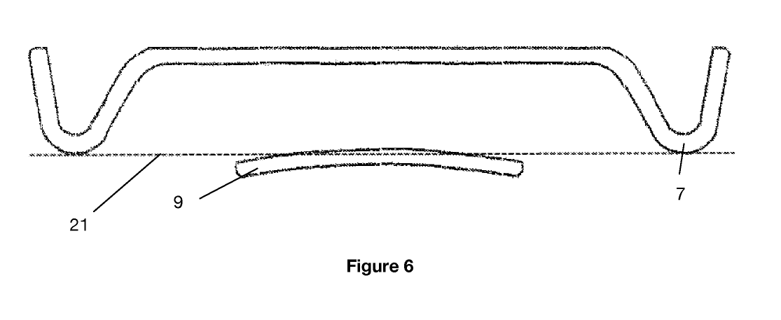

FIG. 5 shows a sectional view of a cable hanger and a flexible cable;

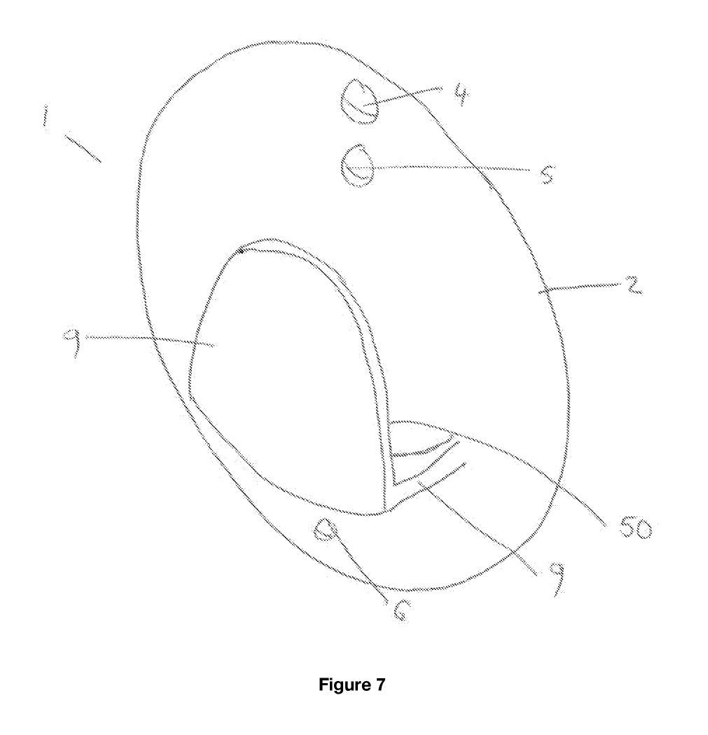

FIG. 6 shows sectional view of another embodiment of a cable hanger;

FIG. 7 shows an another cable hanger;

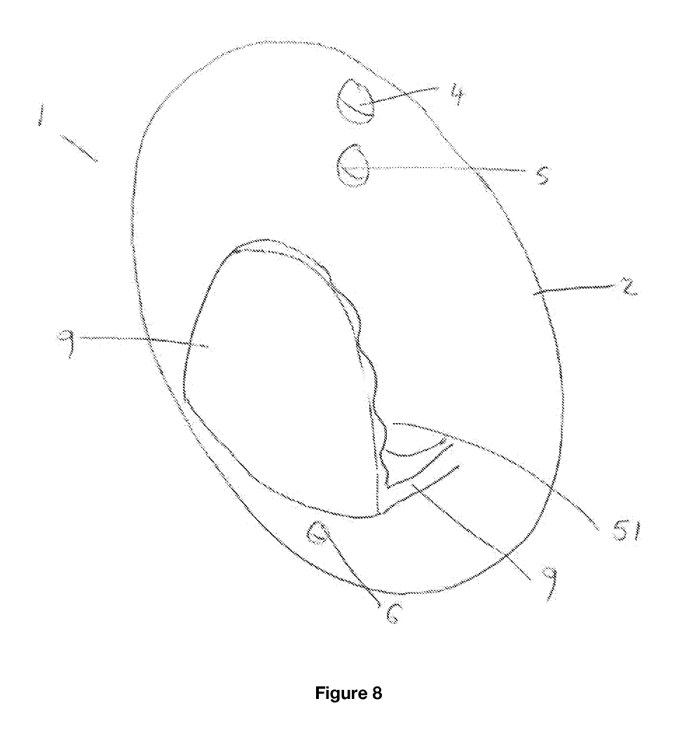

FIG. 8 shows an another cable hanger;

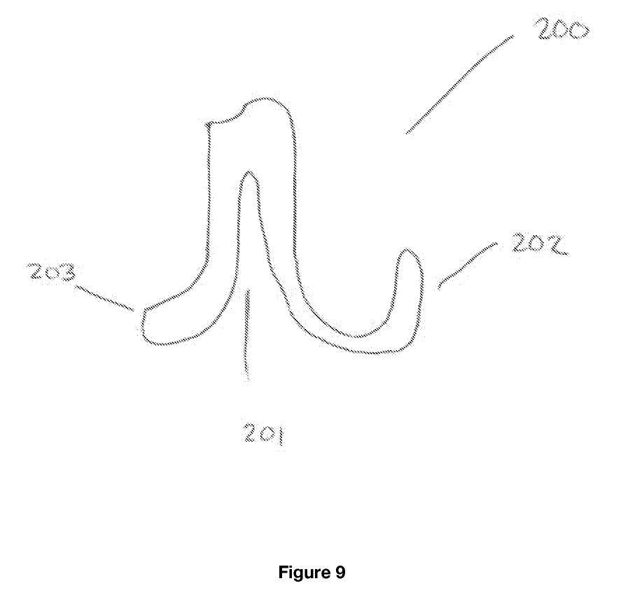

FIG. 9 shows a saddle for use with a cable hanger;

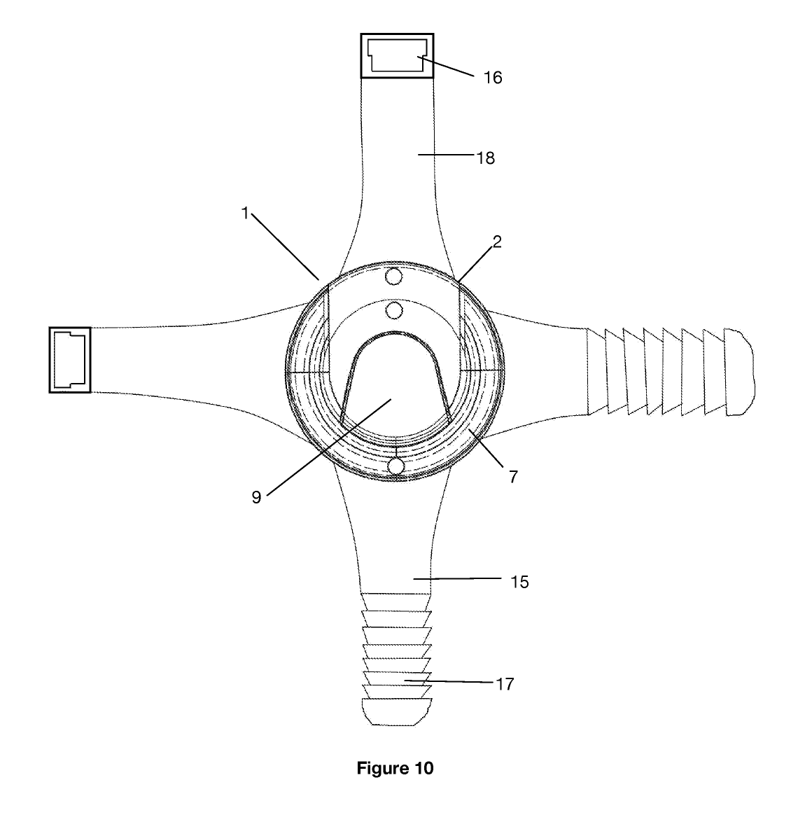

FIG. 10 shows an another cable hanger;

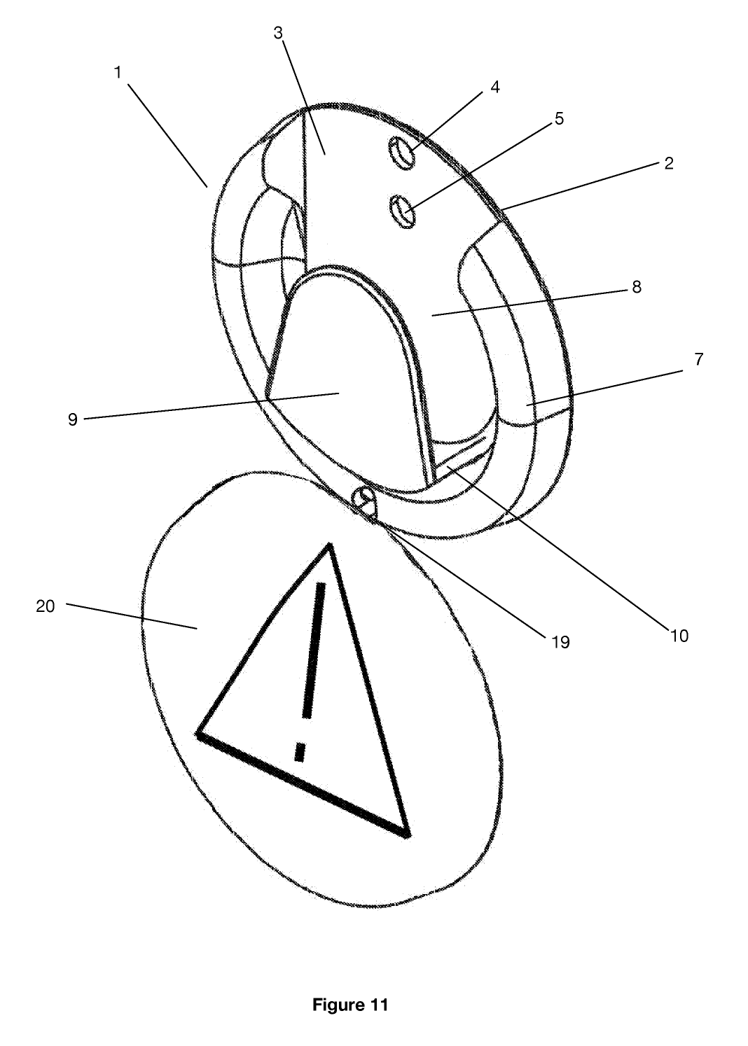

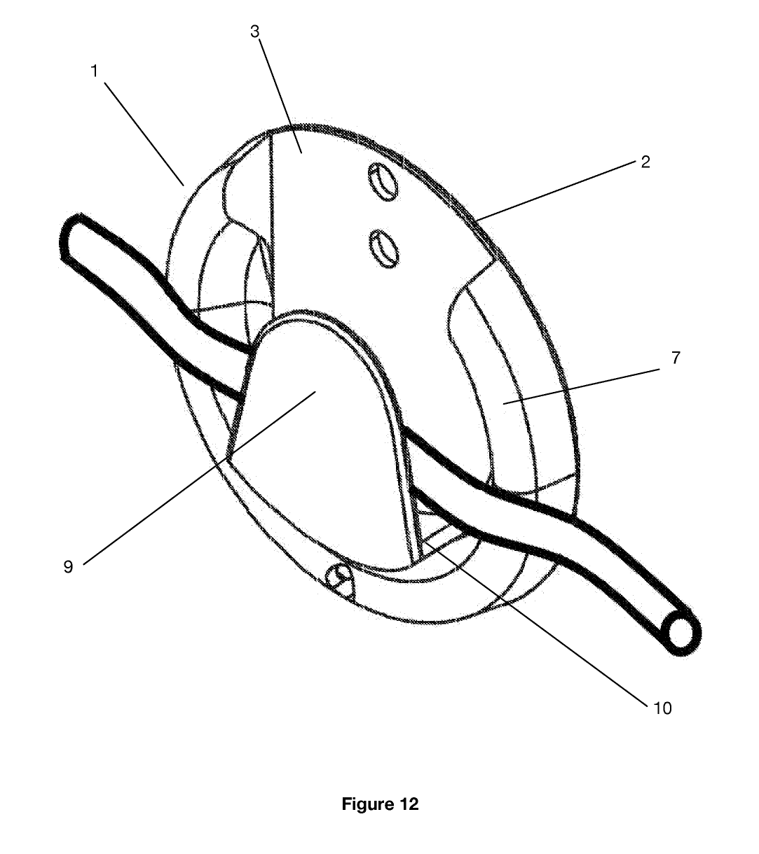

FIG. 11 shows an another cable hanger;

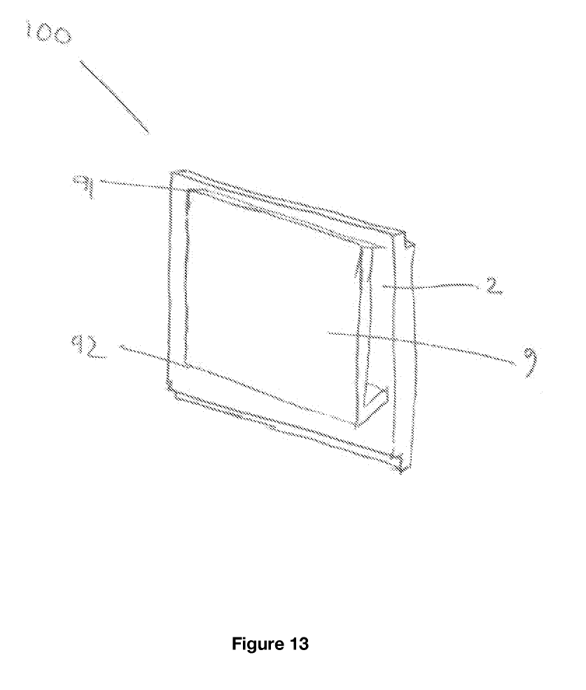

FIG. 12 shows an another cable hanger;

FIG. 13 shows an another cable hanger; and

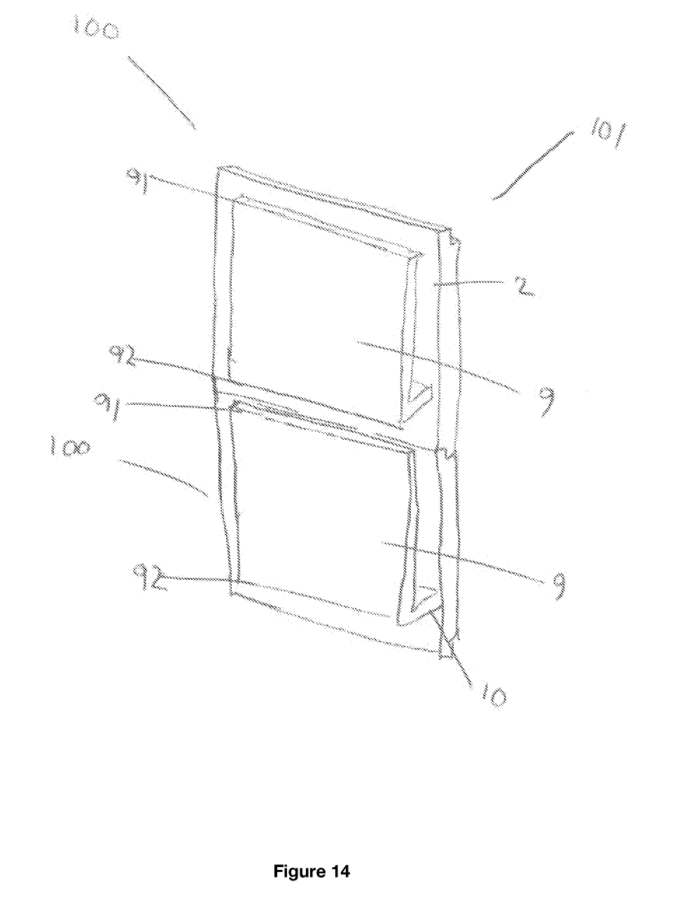

FIG. 14 shows a yet another cable hanger.

Turning firstly to FIG. 1, a cable hanger is shown at 1. Cable hanger 1 includes a main body section 2 which has a substantially planar attachment face (not visible in FIG. 1) and a front face 3. In the embodiment shown in FIGS. 1 and 2, the main body section 2 takes a substantially circular shape. However, it is to be understood that the main body section 2 may take any suitable shape which could, for instance, be square, rectangular or, triangular, dependent on the intended application of the cable hanger 1. The main body section 2 has apertures 4, 5, 6 formed therethrough, one or two 4, 5 near the top edge (if two apertures are provided, one may be placed above the other) and one 6 near the bottom edge of the main body section 2.

In some embodiments, the main body section 2 also has a raised lip portion 7 around part of the outer edge of the front face, extending generally away from the front face 3. In the embodiment shown in FIG. 1, the lip portion 7 does not extend all of the way around the circumference of the front face 3, but extends substantially between approximately the 2 o'clock and 10 o'clock positions (comparing the front face 3 of the cable hanger 1 to a clock face) of the front face 3 of the cable hanger 1. Of course, the lip portion 7 may be present around the entire perimeter of the main body section 2, may be present only at each side of the main body section 2, or may be presented in any other suitable configuration. The lip portion 7 preferably has a rounded top surface. The central region 8 of the front face 3 is generally flat and planar. The lip portion 7 protrudes outwardly by a greater amount than the central region 8.

Other embodiments do not include the raised lip portion 7—these embodiments will be discussed in more detail later.

Furthermore, an elongate tongue 9 portion is attached to the main body section 2. One end of the tongue portion 9 is attached to the main body section 2 by way of an attachment portion 10. The attachment portion serves to separate the tongue portion 9 from the main body section 3.

As can be seen more clearly in FIG. 2, in this particular embodiment the attachment portion 10 is substantially perpendicular to the front face 3 of the main body section 2 and the tongue portion 9, affixed to the attachment portion 10, is substantially parallel to the front face 3 of the main body section 2. A cable receiving arrangement 11 is therefore defined by the space between the tongue portion 9 and the front face 3 of the main body section 2. FIG. 2 also shows the lip portion 7 extending around a substantial part of the circumference of the front face 3. The tongue portion 9 lies generally opposite the central region 8 of the front face 2, and preferably does not lie opposite the lip region 7.

The tongue portion 9 of the cable hanger 1 shown in FIGS. 1 and 2 is of a generally elongate shape with rounded corners, in this instance having a rounded trapezoid shape. The tongue portion 9 may take any appropriate shape capable of being affixed at one end to the attachment portion 10, and free at the other.

More generally, the tongue portion 9 and the attachment portion 10 are attached to the main body section 2 of the cable hanger 1, and create a cavity or retaining region in which a cable or cables may be received.

The attachment portion 10 of the cable hanger shown in FIGS. 1 and 2 takes a shape which is complementary to the fixed end of the tongue portion 9, but it is to be understood that this shape may be dependent upon the manufacturing process or intended usage of the cable hanger 1.

In some embodiments, an attachment portion 10 may not be used, and the tongue portion 9 may be attached directly to the main body section 2 of the cable hanger 1, the tongue portion 9 shaped appropriately to form a cavity in which a cable or cables may be received. This will be discussed in more detail later.

As can be seen in FIGS. 2 and 4, the tongue portion 9 of the cable hanger 1 has a concave profile, when viewed from the front of the cable hanger. Also, it can be seen from FIG. 4 that a substantial part of the tongue portion 9 may lie within the bounds of lip portion 7—the central portion of the tongue portion 9 may lie closer to the front face 3 of the cable hanger 1 than the outermost edges of the lip portion 7. FIG. 6 shows a line 21 drawn between the outermost edges of the lip portion 7 which passes through at least a substantial part of tongue portion 9, illustrating this.

The main body section 2, tongue portion 9 and attachment portion 10 may be manufactured from any suitable material, but it is envisaged that all three may be made from the same material, in this case from ABS. However, each of the main body section 2, tongue portion 9 and attachment portion 10 may be made from different materials, dependent on the intended application of the cable hanger 1. The cable hanger 1 shown in FIG. 1 is formed as a single, unitary moulding, but the hanger 1 may be formed using any suitable method, for instance machining, vacuum forming or similar, dependent upon the dimensions of and material selected for the cable hanger 1.

Sections of the lip portion 7 may also be inlaid with or entirely manufactured from a rubber or other high-grip material, if desired. It is, however, to be appreciated that many different materials may be used for the lip portion 7 dependent upon the sought application.

As shown in FIG. 7, the tongue portion 9 or the front surface of the main body 2 may further include a portion of rubber or high-grip material on the inner surface thereof, to aid in gripping a cable or cables placed within the cavity formed between the tongue portion 9 and the main body 2 of the cable hanger 1. The high grip material may include a textured finish formed of a granular or ‘dotted’ finish, either attached to the cable hanger 1 or formed into the surface thereof. Alternatively, a high grip rubber or sandpaper-type material may be added to the surface. It is, however, envisaged that any suitable high-grip or high-friction material or surface may be used, dependent upon the intended use of the hanger 1.

In embodiments which include the rubber or high grip material, the tongue portion 9 may not necessarily take a concave profile when viewed from above.

Alternatively or in addition, as shown in FIG. 8, the inner surface of the tongue portion 9 or the front surface of the main body 2 may include an undulating or rippled surface, shaped such that one or more cables may be accommodated in or between each of the undulations or ripples. In embodiments which include the undulating or rippled surface, the tongue portion 9 may not necessarily take a concave profile when viewed from above. Preferably, the undulations or ripples run substantially perpendicular to the main elongate axis of the tongue 9.

Preferably, the attachment face of the main body section 2 has an adhesive pad attached thereto. Alternatively an adhesive pad may be supplied separately and attached to the attachment face before use. The adhesive pad may take a shape which is complementary to the rear face of the main body section 2 but, of course, may take any suitable shape. The adhesive pad is for removably attaching the cable hanger 1 to a substantially flat surface, and may comprise a peel/peel foam adhesive capable of supporting 67 kg per m² of adhesive. However, it is to be understood that any suitable adhesive may be used.

If the cable hanger 1 is to be used in a more permanent setting, a peel/peel foam adhesive capable of supporting more than 67 kg per m² of adhesive may be used. It is envisaged that if the cable hanger 1 is to be used in a more permanent setting, a saddle 200 (shown in FIG. 9) may be used with the cable hanger 1 to enable power tools or similar items to be hung from the tongue portion 9, to provide an alternative use for the cable hanger 1. This may be of particular use to persons wishing to hang tools in a workshop or van environment.

The saddle 200 is shaped to fit over the tongue portion 9, and provides a larger contact surface for more substantial items, for instance a power saw or power sander, to hang from. If heavy items are to be hung from the saddle 200, the saddle may further include a stabilising leg 203, which contacts the surface to which the cable hanger 1 is attached, providing extra stability and load-bearing capability. The saddle 200 may take any appropriate shape, dependent upon the intended use.

In example, the saddle 200 has a socket 201 into which the tongue portion 9 may fit, and a hook portion 202. When the saddle 200 is attached to the tongue portion 9, the hook 202 presents an upward-facing trough which can be used to hang an object or objects upon. The trough of the hook 202 is preferably wider than the cavity or retaining region of the hanger 1, and may be presented further away from the main body 2 of the hanger 1.

It is envisaged that the cable hanger 1 may accommodate an electrical cable, gas or other fluid pipe, or any other flexible member having a diameter which may be in a range of between 2 mm and 22 mm. The cable or flexible member may be placed between the tongue portion 9 and the main body section 2, in the cable receiving arrangement 11. It is envisaged that the cable will flex as it is placed in the cable receiving arrangement 11, curling around the top surface of the lip portion 7, and also around the convex shape of the tongue portion 9, as shown in FIG. 5.

In combination with the curved profile of the tongue portion 9, the central portion of the tongue portion 9 being closer to the front face 3 of the main body section 2 than the edge sections (also shown in FIGS. 2 and 3) serves to “pinch” and retain a cable or flexible member. Of course, any other suitable method to retain the cable may be employed, for instance teeth or an abrasive surface on the opposing faces of the tongue 9 and main body section 7. FIG. 4 shows a section view of a cable hanger 1, showing the “pinching” action caused by the shape of the tongue 9 and lip portions 7. The curved path around the tongue portion 9 and lip portion 7 ensures that the cable may not slip or be otherwise accidentally displaced from the cable hanger 1—due to the configuration of the tongue 9 and lip portion 7 discussed above, even a cable with a very thin diameter would be “pinched” by the cable hanger.

In embodiments which do not include a lip portion 7, the tongue portion 9 may include a portion of rubber or high-grip material, or the rippled or undulating surface as discussed above. A cable hanger 1 which does not include a lip portion 7 is shown in FIG. 7. As can be seen, the tongue portion 9 takes a concave shape, and includes a section of rubber or high-grip material 50 on the inner face of the tongue portion 9, to ensure effective cable retention.

The shape of the tongue 9 ensures that the cable is “pinched” between the front face 2 of the cable hanger 1 and the tongue 9. Preferably, the cable takes a curved path around the tongue portion 9 to ensure that the cable may not slip or be otherwise accidentally displaced from the cable hanger 1. The portion of rubber or high-grip material serves to reduce the likelihood of a cable being slid or dislodged from within the cavity between the tongue portion 9 and the front face 2 of the cable hanger 1. The curved tongue and/or the rubber or high-grip material effectively ‘pinches’ the cable.

The tongue portion may also (particularly if it is substantially flat), as shown in FIG. 8, include a portion of the rippled or undulating surface 51 as discussed above on the inner face of the tongue portion 9. The rippled or undulating surface may be configured such that a cable may be accommodated within each ripple or undulation, to effectively ‘pinch’ the cable. The rippled or undulated surface may be formed of a rubber or high grip material to improve retention of a cable or cables, serving to reduce the likelihood of a cable being slid or dislodged from within the cavity between the tongue portion 9 and the front face 2 of the cable hanger 1.

It is expected that several cables or flexible members may be accommodated simultaneously in the cable receiving arrangement 11, stacked on top of each other. In the case of the cable hanger 1 shown in FIG. 8, the number of cables which may be accommodated by the tongue portion 9 can be dictated by the pitch of the ripples or undulations which form the undulating surface 51—the pitch of the ripples or undulations may be dictated by the intended application of the cable hanger 1.

The concave or flat outer face 12 of the tongue portion 9 may have a reflector or other adhesive item attached thereto, dependent upon the intended use of the cable hanger 1. For example, if use of the cable hanger 1 in low-light conditions is contemplated, it may be desirable to attach a reflector to aid in locating the cable hanger 1.

It is envisaged that the cable hanger 1 may be affixed to a wall or suitable structure by a number of different methods, dependent upon the intended use of the cable hanger 1 or the location in which the cable hanger 1 is to be used.

The adhesive pad allows a user to affix the cable hanger in the desired location, and remove the cable hanger 1 easily when work is complete or the hanger 1 location or cable route is to be changed. The adhesive pad attached to the cable hanger is user-replaceable—a new pad may be attached when the adhesive quality of the present pad is exhausted—it is preferable that the adhesive pad is capable of supporting the weight of the cable hanger 1 and a number of suspended cables or flexible members.

It is intended that various systems may be employed to retain or attach the cable hanger 1—the topmost 4 and lowermost 6 holes in the main body section 2 of the cable hanger 1 may be used to allow attachment of the cable hanger 1 to a wall or surface by way of screws or nails, or to hang the cable hanger 1 on a pre-existing screw, nail or other type of protuberance. This is intended as an alternative to the adhesive pad, but of course may be used in addition thereto. If, as discussed above, the cable hanger is to be installed in a more permanent setting, a screw may be passed through the topmost hole 4 in the main body 2 of the cable hanger 1 may be used to affix the cable hanger 1 to a wall or other surface.

Furthermore, the lower of the two apertures 5 in the upper part of the main body section 2 is intended for use with a so-called “weep dowel”. When a building is constructed, weep-holes are created in the brickwork to allow moisture to escape from the building as the mortar and other similar substances dry—it may be desirable to use a cable hanger 1 in or on a newly-constructed building and therefore the easiest attachment location may be these weep-holes.

A weep dowel may be provided for use with the cable hanger 1, to be used in combination with the weep dowel hole 5 of the cable hanger 1 and a weep-hole in a building. Weep-holes in buildings are generally 6 mm in diameter and therefore the outer diameter of the weep dowel may be substantially 6 mm. Weep-holes in buildings are generally 6 mm in diameter and therefore the outer diameter of the weep dowel may be substantially 6 mm. The weep dowel is an elongate nail-like dowel, formed from plastic or nylon or any other suitable material, with annular flanges provided along the length of the dowel to provide a snug fit between the weep dowel and the weep-hole. The weep dowel is intended to be removable and re-useable, and an attachment means (not shown) may be provided upon the cable hanger 1 to store the weep dowel when not in use. Of course, the weep dowel may take any suitable form to fit into and be retained within a weep-hole and may not necessarily correspond to the above description.

These varying attachment methods allow for convenient and rapid deployment and removal of the cable hanger 1, and it is to be understood that any other suitable retaining means may be employed, for instance hook-and-loop tape, magnets, or any other appropriate system or means.

Turning now to FIG. 10, an alternative version of the cable hanger 1 is shown, which incorporates an alternative retaining method. This alternative retaining method takes the form of re-useable, flexible straps 15, preferably formed from plastic, which would likely be of use where cables are run on or near scaffolding or other, similar types of framework. These straps 15 may be formed as an integral part of the cable hanger 1, or may alternatively be formed separately and attached to the main body section 2 of the cable hanger 1, for instance as a ring with the straps 15 attached thereto, subsequently affixed to the cable hanger 1.

The plastic straps 15 are provided at each of the cardinal compass points of the cable hanger, illustrated in FIG. 10, with opposing straps having complementary fitments 16, 17 provided thereon. For instance, the straps 15 shown in FIG. 10 are closed by way of a tooth-and-aperture system 16, 17, so that the strap may be ratcheted shut. These straps 15 may then easily be released to facilitate removal of the cable hanger 1.

It is envisaged that these straps 15 may be wrapped around a scaffolding pole or similar, with the straps 15 locked shut to affix the cable hanger 1 in place. These straps 15 may be used in place of an adhesive pad, but of course the straps 15 may be used in addition to the adhesive pad if a more secure fixing is desired. The straps 15 may take any suitable form, for instance tie-wraps or hook-and-loop fastening, it is to be understood that it is desirable that the straps 15 should be releasable. Of course, attachment means that result in permanent closure may be utilised, and this may be useful when a cable hanger 1 is to be used in a location where work may continue for many months, or where it may be desirable to have a permanent cable hanger 1.

These straps 15 may also be useful when an adhesive pad is in place on the rear of the cable hanger 1—the straps 15 may be closed when the cable hanger 1 is not in use to protect the adhesive pad. This would avoid the adhesive pad making undesired contact with a surface, thereby avoiding the cable hanger 1 becoming affixed for instance inside a tool box or bag.

Embodiments of the cable hanger 1 which incorporate straps 15 may be used in combination with an adhesive pad, with the topmost strap 18 modified to incorporate additional hooks or other retainers to accommodate further, narrow cables. The number of additional hooks present will, of course, depend upon the length of the straps 15, 18 affixed to the cable hanger and the number of additional cables which are to be accommodated. The hooks incorporated into the straps 1 may be removable or may be integrally formed into the straps 15, 18.

FIG. 11 shows a cable hanger 1 similar to that shown in FIG. 1, but with the added feature of a hinged flap 20. The hinged flap 20 is attached to the cable hanger 1, preferably to the main body section 2 of the cable hanger 1. In the example shown in FIG. 11, the hinged flap 20 is attached to the lowermost edge 19 of the main body section 2. It is envisaged that the hinged flap 20 is manufactured from the same material as the other parts of the cable hanger 1, and in the example shown in FIG. 11, the entire cable hanger 1, including the hinged flap, are formed as one section. Of course, the hinged flap 20 may be formed of any suitable material and could be affixed to any appropriate part of the cable hanger 1 dependent upon the intended application.

The hinged flap 20 may be folded over the adhesive pad when the cable hanger 1 is not in use to protect the adhesive pad and avoid the hanger 1 becoming attached to a surface in an undesired location, for instance inside a van or tool box. When it is desired to use the cable hanger 1, the hinged flap 20 may be folded away from the adhesive pad and folded, in this instance, downwards. The cable hanger 1 may then be attached in the desired location.

The hinged flap 20 may also be used to present information or a warning about the nature of the cable, pipe or flexible member affixed in the cable hanger 1. Such information or a warning may be required under health and safety legislation, may be used to identify the company working, or, for instance, could be used to provide information about the type of tool attached to the end of a hung cable. Alternatively a simple warning, for instance “Warning—Power Cables Present” may be printed upon the outer side of the hinged flap 20. Of course, any sort of information or warning may be presented, or the flap 20 could be left un-printed. Legislation may require, however, that a warning or information be presented.

FIG. 12 shows a cable hanger 1 in use, with a cable in the retaining arrangement.

It is to be understood that any suitable method may be employed to protect or cover the adhesive pad, and a non-attached cover may be used. Of course, it is most desirable to use a cover that remains attached to the cable hanger 1 to make deployment easier, and to reduce the likelihood of losing the adhesive pad cover.

A further embodiment of the cable hanger 100 is shown in FIGS. 13 and 14. It is envisaged that this particular embodiment may be used for cable management in an office or workshop environment, to ensure safe and tidy cable routing.

As can be seen from FIG. 13, the cable hanger has a flat main body portion 2 and a tongue portion 9, the tongue portion 9 attached to the main body portion 2 by way of an attachment portion 10. Further, the top and bottom edges of the cable hanger 100 are formed such that multiple cable hangers 100 may be clipped, ganged or joined together to form a ‘chain’ 101 of cable hangers 100, as shown in FIG. 11.

As demonstrated in FIG. 14, the top portion 91 of the tongue portion 9 of one cable hanger 100 in the chain of cable hangers 101 may almost touch the lower portion 92 of the tongue portion 9 a neighbouring cable hanger 100. The tongue portion 9 of each cable hanger 100 may be flexible, to enable a cable or flexible member to be placed in the cavity formed between the tongue portion 9 and the main body 2 of the cable hanger 100.

The cable hangers 100 forming the chain 101 may be attached together in a number of different ways. In FIG. 11, complementary rabbets (or ‘rebates’) are formed on the top 120 and bottom 121 edges of the cable hanger 100, to enable the hangers 100 to be ‘clipped’ to one another when affixed to a surface. It is to be understood that any suitable method may be used to attach the cable hangers 100 together to form a chain 101. Such methods may include a ‘tongue and groove’ system, clips, complementary shapes, adhesives, or any other appropriate method.

If the cable hanger 100 is to be used in an office environment, the tongue portion 9 and attachment portion 10 (if used) may be sized to accommodate cables having an external diameter of between 1 mm and 6 mm. However, it is to be understood that the cable hanger 100 may be dimensioned to accommodate cables of any size. Particularly, if the cable hanger 100 is to be used in a workshop environment, it may be dimensioned to accommodate cables having an outer diameter of greater than 6 mm.

The shape of the cable hanger 100 may be any appropriate shape, and the outer perimeter of the cable hanger 100 may take a curved profile. However, it is to be understood that to enable the cable hangers 100 to be affixed to one another to form a chain 101, the shape of the cable hanger 100 will include edges which are complementary to enable a chain 101 to be formed.

Use of the cable hanger 1 will now be described. If it is necessary to run an electrical cable or gas pipe on a building site or in a construction environment, firstly the route for the cable or pipe would be assessed. Then, it is envisaged that the required number of cable hangers 1 would be determined, with the cable hangers 1 subsequently deployed along the cable or pipe route to ensure that none of the cable or pipe makes contact with the floor.

The desired number of cable hangers 1 would then be affixed in the required locations, either by way of adhesive pads, screws, nails, straps 15, 18 or weep-dowels, dependent upon the location of the cable hangers 1. Of course, a combination of these fixing methods could be exploited. For instance, if it is desired to run a cable or pipe from inside a newly-constructed building to a scaffold outside, it may be necessary to use a combination of adhesive pads inside the building, straps 15, 18 on scaffolding poles or towers and weep-dowels on the brick-work of the building.

Once the cable hangers 1 have been deployed, the cable or pipe may then be hung between the hangers and work may commence. If the contractor needs to move to an alternative location, the cable hangers 1 can easily be removed from their current locations, new locations identified and the cable hangers 1 subsequently re-located. Work may then continue, with the cable or pipe safely lifted away from the ground or floor, raised to a safe height. When cable hangers 1 are used, the cable or pipe is safely affixed between the tongue 9 portion and the front face 3 of the main body section 2 of each cable hanger 1.

Once work in has been completed, the user may then remove the cable or pipe from each hanger 1 and then remove the cable hangers 1 from the wall, scaffolding and/or weep holes. If adhesive pads have been used, a protective cover may then be applied to each cable hanger 1, which may be the hinged flap 20 discussed above. The cable hangers can then be stored safely for future use.

Of course, it is envisaged that alternative methods may be employed to use the cable hangers 1, and varying sizes of cable hanger 1 may be used dependent on the desired application. It is also intended that the cable hangers 1 may be able to accommodate gas lines as well as electricity cables, to cater for various applications, and furthermore that each hanger 1 may safely accommodate a multitude of cables.

Use of the cable hanger 100 differs only in that the cable hanger 100 or chain of cable hangers 101 may be affixed in a more permanent fashion, and because the top portion 91 of one tongue portion 9 almost touches the lower portion 92 of a neighbouring tongue portion 9, a user may have to bend the tongue portion 9 away from the main body 2 of the cable hanger 100 to enable a cable or flexible member to be placed between the tongue 9 and the body 2.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, the following claims or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A cable hanger comprising:
a main body section having an attachment face and a front face; and
an elongate tongue section, wherein:
the tongue section is attached at one end to the main body section by way of an attachment region and has a free end;
the front face has raised edge portions and a central portion, the central portion being located generally opposite the tongue section, and the edge portions protruding outwardly by a greater amount than the central portions; and
a retaining region is defined between the front face of the main body section and a rear face of the tongue section, the retaining region being capable of accommodating and retaining a cable.

2. A cable hanger comprising:
a main body section having an attachment face, a front face, a first edge and a second edge; and
an elongate tongue section, wherein:
the tongue section is attached at one end to the main body section and has a free end;
the front face has a central portion, the central portion being located generally opposite the tongue section;
the first edge and second edge are so shaped as to be complementary, the first edge having a first attachment arrangement and the second edge having a second attachment arrangement;
the first and second attachment arrangements cooperate with each other such that if the first edge of the hanger is placed against the second edge of an identical hanger, the first and second attachment arrangements engage with one another and register the hanger and the identical hanger in place with respect to one another;
the tongue portion has an inner face which is generally opposite the front face of the central portion; and
a retaining region is defined between the front face of the main body section and the inner face of the tongue section, the retaining region being capable of accommodating and retaining a cable.

3. A cable hanger according to claim 2 wherein the first and second attachment arrangements are complimentary rabbets.

4. A cable hanger according to claim 2 wherein the first and second attachment arrangements are formed of a tongue-and-groove.

5. A cable hanger comprising:
a main body section having an attachment face and a front face; and
an elongate tongue section, wherein:
the tongue section is attached at one end to the main body section and has a free end;
the front face has a central portion, the central portion being located generally opposite the tongue section;
the tongue portion has an inner face which is generally opposite the front face of the central portion, the inner face and/or the central portion having an undulating surface, with spaced-apart ridges running perpendicular to the elongate axis of the tongue section; and
a retaining region is defined between the front face of the main body section and the inner face of the tongue section, the retaining region being capable of accommodating and retaining a cable, between adjacent ridges.

6. A cable hanger comprising:
a main body section having an attachment face and a front face; and
an elongate tongue section, wherein:
the tongue section is attached at one end to the main body section and has a free end;
the front face has a central portion, the central portion being located generally opposite the tongue section;
the tongue portion has an inner face which is generally opposite the front face of the central portion, the inner face and/or the central portion having a high-grip surface which comprises a region of a different material, or is treated or formed to grip a cable; and
a retaining region is defined between the front face of the main body section and the inner face of the tongue section, the retaining region being capable of accommodating and retaining a cable.

7. A cable hanger according to claim 1, wherein at least a section of the tongue portion or front face is formed of or includes a high-grip surface which comprises a region of a different material, or is treated or formed to grip a cable.

8. A cable hanger according to claim 6 wherein the high-grip surface is a roughened surface is a textured surface, is formed of a plastics material, or is formed of a rubber material.

9. A cable hanger according to claim 1, wherein the elongate tongue section has a curved shape, such that a central portion of the tongue section is closer to front face of the main body section than edge sections of the tongue section.

10. A cable hanger according to claim 2, wherein the tongue section is attached to the main body section by way of an attachment region.

11. A cable hanger according to claim 1, wherein the attachment face includes an attachment arrangement.

12. A cable hanger according to claim 11, wherein the attachment arrangement comprises an adhesive pad.

13. A cable hanger according to claim 1, wherein the edge portions extend substantially all of the way around the outer edge of the front face.

14. A cable hanger according to claim 1, wherein the edge portions extend part of the way around the outer edge of the front face.

15. A cable hanger according to claim 1, wherein apertures are provided through the main body section.

16. A cable hanger according to claim 1, wherein a strap or straps are provided, extending generally away from an outer perimeter of the main body section.

17. A cable hanger according to claim 16, wherein the straps are flexible.

18. A cable hanger according to claim 16, wherein the straps include fixing arrangements.

19. A hanging arrangement comprising:
a cable hanger having a main body section having an attachment face and a front face, an elongate tongue section, the tongue section attached at one end to the main body section and has a free end, a retaining region of a defined between the front face of the main body section and a rear face of the tongue section; and
an attachment arrangement having an engagement portion and a hanging portion, the engagement portion shaped to receive the tongue section of the cable hanger, and the hanging portion being shaped so that an object may hang thereon.

20. A hanging arrangement according to claim 19, wherein the hanging portion is trough-shaped or is peg-shaped.
